(19) United States
(12) Patent Application Publication
(10) Pub. No.: US 2007/0129033 A1
(43) Pub. Date: Jun. 7, 2007

(54) Base station receiver capable of generating pseudo noise signals

(75) Inventor: In Gon Kim, Gyeonggi-do (KR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: UTSTARCOM KOREA LIMITED, ALAMEDA, CA (US)

(21) Appl. No.: 10/555,334

(22) PCT Filed: May 28, 2004
(86) PCT No.: PCT/KR04/01266

§ 371 Date: Feb. 14, 2007

(30) Foreign Application Priority Data
May 29, 2005 (KR) 10-2003-0034427

(51) Int. Cl. H04B 17/02

(52) U.S. Cl. 455/136; 455/39; 455/130

(57) ABSTRACT

A base station receiver increases noise factor by introducing Pseudo-Noise (PN) signals when testing an effect of a cell size by a reverse virtual call in a CDMA2000-1x system. The receiver of the present invention comprises: a Front-End Unit (FEU), an Analog Down-Converter Card Assembly (ADCA), a Digital Down-Converter Card Assembly (DDCA) including an Analog/Digital Converter (ADC) and a Digital Signal Processor (DSP) for processing digital signals, and a Multi-Rate Channel Card Assembly (MCCA). The Digital Signal Processor (DSP) comprises: first and second multipliers for down-converting IF-band digital signals outputted from the ADC into base-band complex signals; a Pseudo-Noise (PN) signal generator for generating PN signals; a PN gain adjuster for adjusting a gain of the PN signal generated from the PN signal generator; first and second adders for adding the base-band complex signals outputted from the first and second multipliers to the Pn signals outputted from the PN gain adjuster, respectively; and first and second automatic gain controllers for controlling 1 (in-phase) and Q (quadrature-phase) signals outputted from the first and second adders for transmission to the MCCA.

### TECHNICAL FIELD

The present invention generally relates to a base station receiver, and more particularly to a base station receiver wherein noise factor is increased by introducing Pseudo-Noise (PN) signals when testing an effect of a cell size by a reverse virtual call in a CDMA2000-1x system.

### BACKGROUND ART

In general, a CDMA2000-1x system uses an Other User Noise Simulator (OUNS) to test the service area and capacity of a base station by using the reverse virtual call.

Virtual calls of other users are noise and increased noise level at the receiver of the base station. Further, the increased noise level has certain effect on the cell load.

FIG. 1 shows a block diagram of a receiver of a conventional CDMA2000-1x system (2Generation system).

As shown, the receiver comprises an antenna 11; a signal processor 12 for amplifying signals received from the antenna 11 and performing a base-band filtering on the amplified signal; and a Down Converter Assembly (DNCA) 20 for down-converting high frequency signals processed by the signal processor 12 into intermediate frequency signals.

DNCA 20 comprises a flower attenuator 21 and an automatic gain controller 22.

The conventional CDMA2000-1x system, as configured above, generates and uses the noise by the reverse virtual call through adjusting attenuation values of the flower attenuator 21.

However, a 3G system (shown in FIG. 2), which is more advanced than the 2G system, is currently being utilized.

FIG. 2 shows a block diagram of a receiver of a CMA2000-1x system (3G system).

As shown, the receiver comprises an antenna 31; a Front-End Unit (FEU) 32 for processing RF signals; an Analog Down-Converter Card Assembly (ADCA) 33; a Digital Down-Converter Card Assembly (DDCA) 34 for digitally processing signals from a base-band frequency to an intermediate frequency (IF) of about 70 MHz; and a Multi-Rate Channel Card Assembly (MCCA) 35.

In the receiver of the CDMA2000-1x system (3G system) as configured above, the flower attenuator is provided in ADCA 33 and the AGC in DDCA 34. Therefore, the noise by the reverse virtual call cannot be generated through the implementation of the conventional method.

### DISCLOSURE OF THE INVENTION

The object of the present invention is to provide a base station receiver wherein noise factor is increased by introducing Pseudo-Noise (PN) signals when testing an effect of a cell size by a reverse virtual call in a CDMA2000-1x system. This is to generate the noise by the reverse virtual call in the CDMA2000-1x system (3G system).

To accomplish the above-mentioned object, the present invention increases the noise factor by using characteristics of PN signals in a Digital Signal Processor (DSP) that processes signals within a DDCA board.

The receiver of the present invention comprises: a Front-End Unit (FEU); an Analog Down-Converter Card Assembly (ADCA); a Digital Down-Converter Card Assembly (DDCA) including an Analog/Digital Converter (ADC) and a Digital Signal Processor (DSP) for processing digital signals; and a Multi-Rate Channel Card Assembly (MCCA). The Digital Signal Processor (DSP) comprises: first and second multipliers for down-converting IF-band digital signals outputted from the ADC into base-band complex signals; a Pseudo-Noise (PN) signal generator for generating PN signals; a PN gain adjuster for adjusting a gain of the PN signal generated from the PN signal generator; first and second adders for adding the base-band complex signals outputted from the first and second multiplier to the PN signals outputted from the PN gain adjuster, respectively; and first and second automatic gain controllers for controlling I (in-phase) and Q (quadrature-phase) signals outputted from the first and second adders for transmission to the MCCA.

### BRIEF DESCRIPTION OF DRAWINGS

FIG. 1 illustrates a block diagram of a receiver of a conventional CDMA2000-1x system (2G system).

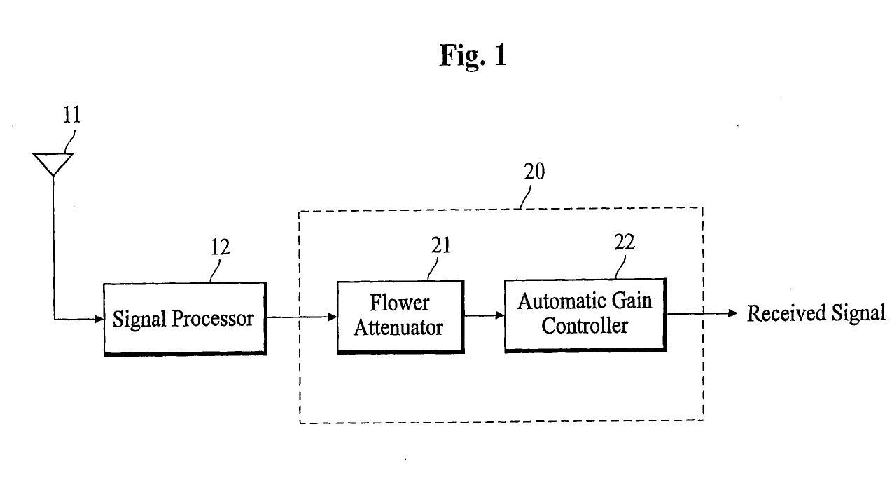

FIG. 2 illustrates a block diagram of a receiver of a CMA2000-1x system (3G system).

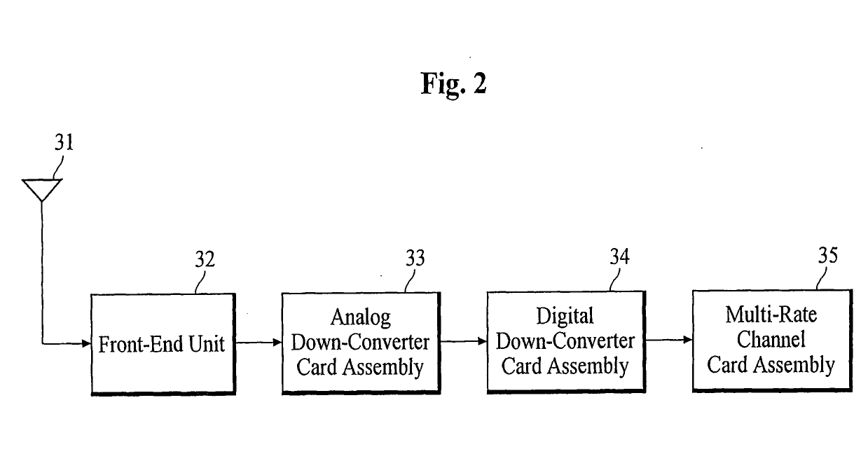

FIG. 3 illustrates a block diagram of a Digital Down-Converter Card Assembly (DDCA) according to an embodiment of the present invention.

### BEST MODE FOR CARRYING OUT THE INVENTION

The embodiment of the present invention will be described with reference to the accompanying drawings and in accordance with the above-identified technical scope of the present invention.

A receive sensitivity of a base station is a minimum signal power that CDMA signals from a mobile station which are received by an antenna of the base station. Frame Error Rate (FER) of the received CDMA signals is maintained within 1%. More specifically, the receive sensitivity checks whether the base station receiver can receive the CDMA signals although a mobile station transmits the CDMA signals of low power. Therefore, the main factor which determines the receive sensitivity can define the performance of a Cell Site Modem (CSM) and the receive noise factor of the base station.

The receive sensitivity of the base station can be represented as Equations 1 and 2 provided below:

$$\begin{matrix}{SNR}_{min - required} ( dB ) = \frac{{E}_{b}}{{N}_{o}} ( dB ) - \frac{W}{R} ( dB ) , & ( Eq . 1 ) \\ {RSSI}_{min - required} ( dB m ) = {SNR}_{min - required} ( dB ) + N ( dB m ) , & ( Eq . 2 )\end{matrix}$$

where, N is the thermal noise power in the base station receiver. Equation 2 represents the relation between a Receiver Signal Strength Indicator (RSSI) and the thermal noise power. Further, Equation 2 shows that the receive sensitivity is increased by 1 dB as the noise is increased by 1 dB.

Here, the thermal noise power N in the receiver can be represented as Equation 3 provided below:
N=kTFW=N₀W, (Eq. 3)
where, k=Boatman's constant (1.38 s 10⁻²³ jules/° K.); T=reference noise source temperature (293° K.); F=noise factor; W=effective noise bandwidth at the input (1.2288 MHz); Noise Figure (dB)=NF×10 log₁₀ F.

When considering the noise caused by interference of other users, signal to noise ratio can be represented by Equation 4 provided below:

$${SNR}_{min - required} = \frac{{RSSI}_{min - required}}{N + I} = \frac{{RSSI}_{min - required}}{{N}_{T}} \qquad ( Eq . 4 )$$

where, N is the thermal noise power and I is the total interference power (the same cell interference power+adjacent cell interference power). Therefore, the total noise power can be represented as the sum of N and I.

The relationship between the cell load X and the total interference power can be defined by Equation 5 provided below:

$$X = \frac{I}{N + I} . \qquad ( Eq . 5 )$$

Using Equations 4 and 5, Equation 6 can be obtained as follows:

$$SNR = \frac{RSSI}{N ( 1 + X / ( 1 - X ) )} = \frac{RSSI}{N} ( 1 - X ) , \\ \frac{{E}_{b}}{{N}_{OT}} = SNRW \frac{W}{R} = \frac{RSSIWW}{{N}_{T} WR} = \frac{RSSI}{N} ( 1 - X ) \frac{W}{R} , \qquad ( Eq . 6 )$$

where, N_{OT} is the total noise power density.

To derive a relationship between the RSSI and the cell load, Equation 6 can be defined by Equation 7 provided below:

$$\begin{matrix}RSSI ( dB m ) = \frac{{E}_{b}}{{N}_{OT}} ( dB ) - \frac{W}{R} ( dB ) + N - ( 1 - X ) ( dB ) \\ = \frac{{E}_{b}}{{N}_{OT}} ( dB ) - \frac{W}{R} ( dB ) + NF ( dB ) - 113 ( dBm ) - ( 1 - X ) ( dB ) ,\end{matrix} \qquad ( Eq . 7 )$$

where, the thermal noise power is assumed to be −113 dBm.

The cell loads of 50% and 75% increase the RSSI values to 3 dB and 6 dB, respectively. The effect of the cell load comes from the noise caused by other users.

Therefore, the present invention can generate the noise by other users by adjusting the gain value of the PN signals in a DDCA board.

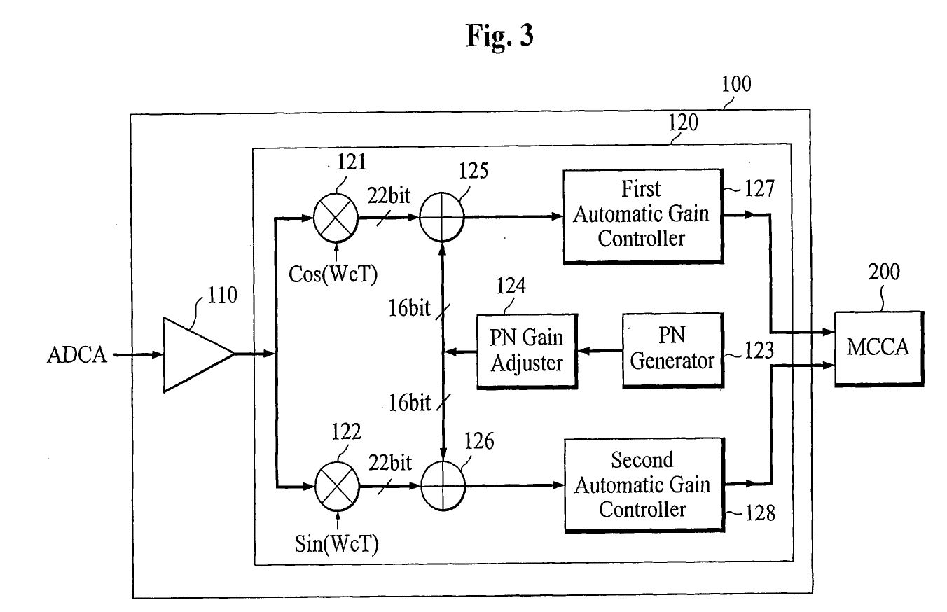

FIG. 3 shows a block diagram of a Digital Down-Converter Card Assembly (DDCA) according to an embodiment of the present invention.

As shown therein, DDCA 100 comprises: an Analog/Digital Converter (ADC) 110 for converting IF-band analog signals from the ADCA into corresponding digital signals; and a Digital Signal Processor (DSP) 120 for down-converting the IF-band digital signals outputted from ADC 110 into base-band digital signals and inserting PN signals into the converted base-band digital signals.

The numeral reference 200 of the figure represents a Multi-Rate Channel Card Assembly (MCCA).

DSP 120 comprises: first and second multipliers 121 and 122 for down-converting the IF-band digital signals outputted from ADC 110 into base-band complex signals (I signal: in-phase and Q signal: quadrature-phase); a Pseudo-Noise (PN) signal generator 123 for generating PN signals; a PN gain adjuster 124 for adjusting a gain of the PN signal generated by PN signal generator 123; first and second adders 125 and 126 for adding the base-band complex signals outputted from first and second multipliers 121 and 122 to the PN signals outputted from PN gain adjuster 124, respectively; and first and second automatic gain controllers 127 and 128 for controlling the I (In-phase) and Q (Quadrature-phase) signals outputted from first and second adders 125 and 126 for transmission to the MCCA.

The operation of the receiver as described above will now be described in more detail.

At first, the first and second multipliers 121 and 122 in DSP 120 down convert the IF-band digital signals outputted from the ADCA into the base-band complex signals (I signal: in-phase and Q signal: quadrature-phase).

Next, PN signal generator 123 generates the PN signals and PN gain adjuster 124 adjusts the gain of the PN signal generated by PN signal generator 123. The gain-adjusted PN signals are used as interference noise of an Other User Noise Simulator (OUNS). The value of PN signal gain corresponding to a cell load can be obtained by measuring the RSSI according to the value of the PN signal gain. Therefore, the value of the PN signal gain is used to implement the OUNS.

Further, the value of the PN signal gain can be easily adjusted by changing only the parameters which change the value of the PN signal gain at an external PC.

Next, the first and second adders 125 and 126 add the PN signals outputted from PN gain adjuster 124 to the base-band complex signals outputted from first and second multipliers 121 and 122, respectively. Then, the first and second automatic gain controllers 127 and 128 control I (In-phase) and Q (Quadrature-phase) signals outputted from first and second adders 125 and 126 for transmission to the MCCA 200.

### INDUSTRIAL APPLICABILITY

According to the present invention, the OUNS is implemented by adjusting the value of the PN signal gain at the DSP provided in the DDCA. As a result, the present invention provides an effect which can easily implement the OUNS in a 3G CDMA2000-1x system.

1. A receiver for use in a base station in a 3G CDMA2000-1x system comprising a Front-End Unit (FEU), an Analog Down-converter card system (ADCA), a digital down-converter card assembly (DDCA) including an analog/digital converter (ADC) and a digital signal processor (DSP) for processing digital signals, and a multi-rate channel card assembly (DDCA), wherein the digital signal processor comprises;
first and second multipliers for down-converting IF-band digital signals outputted from the ADC into base-band complex signals;
a pseudo-noise (PN) signal generator for generating PN signals;
a PN gain adjuster for adjusting a gain of the PN signal generated from the PN signal generator;
first and second adders for adding the base-band complex signals outputted from the first and second multipliers to the PN signals outputted from the PN gain adjuster, respectively; and
first and second automatic gain controllers for controlling I (in-phase) and Q (quadrature-phase) signals outputted from the first and second adders for transmission to the MCCA.

2. The receiver of claim 1, wherein when a parameter for changing a value of the PN signal gain at external is inputted, the PN gain adjuster adjusts the value of the PN signal gain by changing the value of the PN signal gain in response to the parameter.
